(19) United States
(12) Patent Application Publication
(10) Pub. No.: US 2006/0158085 A1
(43) Pub. Date: Jul. 20, 2006

(54) Electron-emission flat panel display

(76) Inventors: Kazunari Noguchi, Chiba (JP); Yuichi Inoue, Mobara (JP); Go Uchida, Mobara (JP); Tomoki Nakamura, Chiba (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/333,283

(22) Filed: Jan. 18, 2006

(30) Foreign Application Priority Data
Jan. 18, 2005 (JP) 2005-010285

(51) Int. Cl. H01J 19/42

(52) U.S. Cl. 313/292

(57) ABSTRACT

In an image display apparatus having scanning lines and data lines mutually intersecting through an insulating layer and a cathode substrate formed with electron-emission areas, whereby electrons accelerated from the electron-emission areas impinge on fluorescent materials provided on an anode substrate to make them luminesce, an intermediate layer is provided at a portion where a scanning line overlaps a data line and the surface of the intermediate layer opposing a spacer is less uneven and flattened. The intermediate layer is, for example, an interlayer insulating film formed on the data line or a thick-film electrode layer formed between the scanning line and the spacer. Alternatively, the cathode substrate is formed with recesses in which the data lines are fitted so as to flatten an intersectional portion of the scanning line and the data line.

### INCORPORATION BY REFERENCE

The present application claims priority from Japanese application JP2005-010285 filed on Jan. 18, 2005, the content of which is hereby incorporated by reference into this application.

### BACKGROUND OF THE INVENTION

The present invention relates to an image display apparatus for displaying an image by making a fluorescent screen luminesce with electron beams emitted from a plurality of cold cathodes arranged in matrix.

Available as an image display apparatus using cold cathodes, especially, a thin flat panel display (hereinafter referred to as “FPD”) is an electron-emission display apparatus (hereinafter referred to as “electron-emission FPD”) for displaying an image by causing a fluorescent screen to luminesce with electron beams.

JP-A-9-204889 describes that as the size of an electron-emission FPD increases, a plurality of spacers need to be interposed between a substrate and a front panel in order to hold a vacuum space inside the panel in the teeth of atmospheric pressure, giving a description of an image display apparatus in which the substrate and front panel are made of synthetic resin and the spacers are formed integrally with the substrate or the front panel.

Also described in U.S. Pat. No. 6,259,198 is a display apparatus having a plurality of insulating spacers provided for a back substrate of a FDP using electron-emission devices of metal-insulator-metal (MIM) structure.

In addition, U.S. Pat. No. 6,274,972 discloses an electron-emission FPD of a structure in which spacers are arranged on wiring conductors formed on a substrate.

### SUMMARY OF THE INVENTION

In the electron-emission FPD having a cathode substrate structure in which data lines and scanning lines orthogonal thereto are laminated on a cathode substrate through the medium of an insulating layer, the cathode substrate and an anode substrate are supported by spacers standing on the scanning lines and a spatial cavity between both the substrates is evacuated to vacuum. Accordingly, a large pressure is applied externally to the cavity between the cathode and anode substrates, concentrating on the spacers.

The data lines and scanning lines formed on the cathode substrate are orthogonal to each other with intervention of the insulating film and a portion where a data line is in register with a scanning line, that is, an overlap portion is locally raised in comparison with a portion devoid of overlap. When a spacer is laid on the scanning line to stand thereon, pressure is concentrated on the raised portion and the insulating film between the wiring conductors will be crushed to breakage, giving rise to a possibility that dielectric breakdown will take place. Especially, a problem that breakdown takes place at the edge of a data line has been considered seriously.

Accordingly, an object of the present invention is to provide an image display apparatus capable of preventing dielectric breakdown of a layer between a scanning line and a data line.

To accomplish the above object, according to the present invention, an intermediate layer is provided at a portion where a scanning line overlaps a data line and the surface of the intermediate layer confronting a spacer is reduced in unevenness and fattened. For example, the intermediate layer is an interlayer insulating film formed on a data line or alternatively, it may be a thick-film electrode layer formed between a scanning line and a spacer. Further, according to the invention, a recess is formed in the cathode substrate and a data line is fitted in the recess to flatten an intersectional portion between a scanning line and a data line.

Since raised portions on a scanning line can be depressed, pressures imposed by the spacers are not concentrated on only the overlap portion between the scanning line and each of the data lines and dispersed to the whole of the scanning line. As a result, breakage of the inter-insulating layer can be avoided. Because of elimination of the dielectric breakdown, it is difficult to occur breakage of pixels attributable to the application of atmospheric pressure and loading.

Other objects, features and advantages of the invention will become apparent from the following description of the embodiments of the invention taken in conjunction with the accompanying drawings.

### BRIEF DESCRIPTION OF THE DRAWINGS

FIG. 1 is a plan view showing an embodiment of an image display apparatus according to the present invention.

FIG. 2 is an enlarged diagram of a dotted line portion surrounding electron-emission areas S shown in FIG. 1.

FIG. 3 is a cross-sectional view of a cathode substrate taken on line A-A′ in FIG. 2.

FIG. 4 is a cross-sectional view of the cathode substrate taken on line B-B′ in FIG. 2.

FIG. 5 is a cross-sectional view of the cathode substrate taken on line C-C′ in FIG. 2.

FIG. 6 is a cross-sectional view of a cathode substrate, as taken on A-A′ line in FIG. 2, to show a second embodiment of the image display apparatus of the invention.

FIG. 7 is a cross-sectional view of a cathode substrate, as taken on A-A′ line in FIG. 2, to show a third embodiment of the image display apparatus of the invention.

FIG. 8 is a cross-sectional view of a cathode substrate, as taken on A-A′ line in FIG. 2, to show a fourth embodiment of the image display apparatus of the invention.

### DESCRIPION OF THE EMBODIMENTS

The present invention will now be described by way of example with reference to the accompanying drawings.

### Embodiment 1

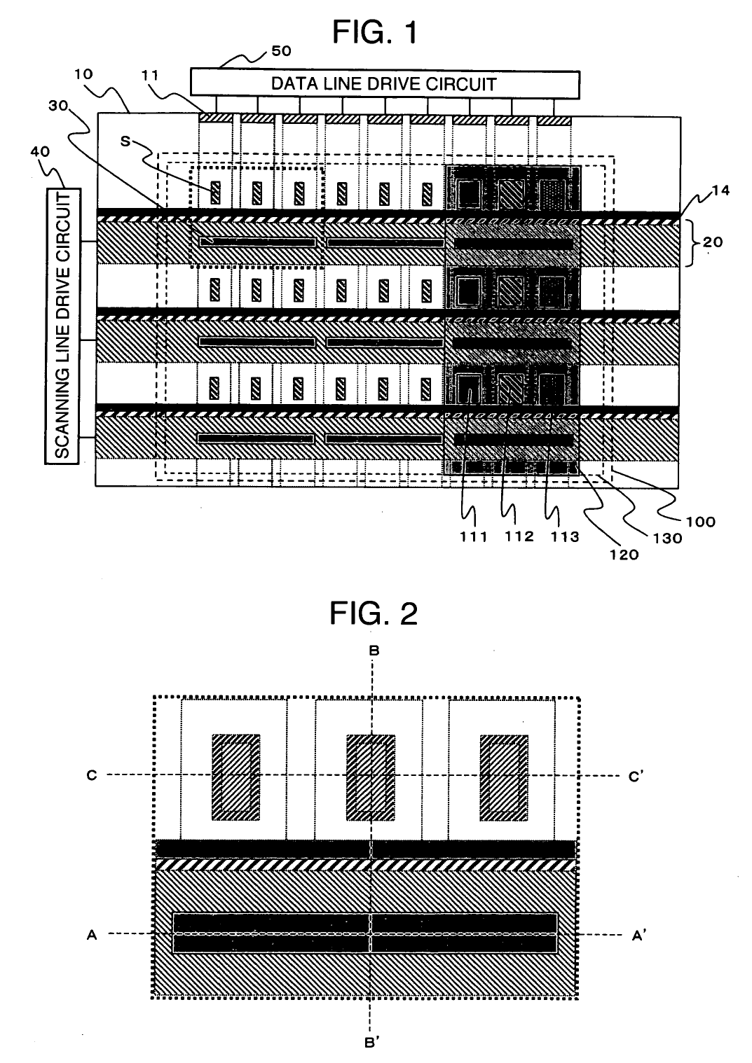

Referring to FIG. 1 showing an image display apparatus according to the present invention in plan view form, stripe-shaped data lines 11 each formed with electron-emission areas S are arranged on a cathode substrate 10. Stripe-shaped scanning lines 20 intersecting the data lines 11 are formed above the data lines 11 through an interlayer insulating film 14. Spacers 30 are laid on each of the scanning lines 20.

The inner surface of an anode substrate 100 confronting the cathode substrate 10 is-coated with red color fluorescent materials 111, green color fluorescent materials 112 and blue color fluorescent materials 113 which are partitioned by a black matrix 120 with a view to increasing contrast and an anode electrode (metal backing) 130 to be applied with a high voltage of several kilovolts or more is vapor-deposited to cover the fluorescent materials.

The cathode substrate 10 and anode substrate 100 are bonded together through the medium of the spacers 30 of high mechanical strength sufficient to protect a panel from atmospheric pressure. The spacers 30 are arranged above the scanning lines 20 on the cathode substrate 10 such that they can underlie the black matrix 120 of anode substrate 100 so as to be concealed thereby.

The data lines 11 are connected to a data line drive circuit 50 for supplying image data and the scanning lines 20 are connected to a scanning line drive circuit 40 for supplying selection signals.

In correspondence with a scanning line 20 selected by the scanning line drive circuit 40, an image data signal is supplied from the data line drive circuit 50 through data lines 11. In correspondence with this image data signal, electrons are emitted from electron-emission areas S. The electrons are accelerated by an electric field of several kilovolts applied across the cathode and anode substrates 10 and 100 to impinge on fluorescent materials to cause them to luminesce, thereby displaying an image.

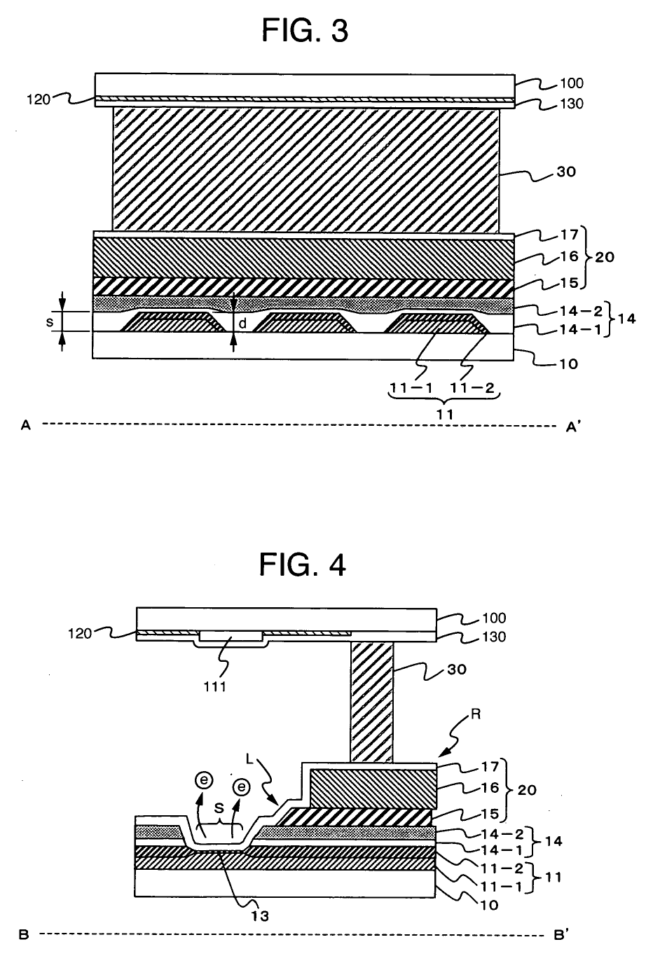

A dotted line portion surrounding the electron-emission areas S shown in FIG. 1 is illustrated exaggeratedly in FIG. 2 and cross-sectional views taken on lines A-A′, B-B′ and C-C′ in FIG. 2 are depicted in FIGS. 3, 4 and 5, respectively.

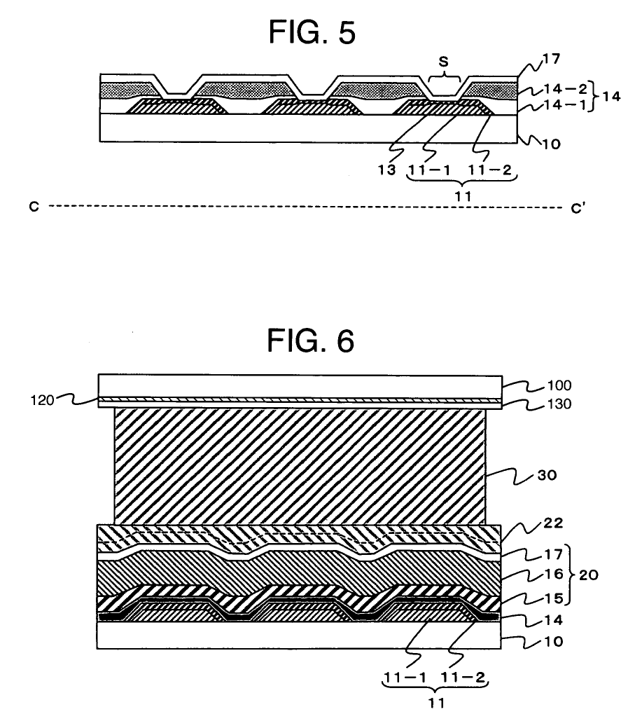

A structure of the cathode substrate 10 will be described with reference to FIGS. 3 to 5. Referring first to FIG. 5, a lower electrode 11-1 formed of a stripe-shaped metal film is formed on the insulating cathode substrate 10 made of glass, for instance. As a material of the lower electrode 11-1, aluminum (Al) or aluminum alloy (Al alloy) is used.

With an electron-emission area S (an area of insulating layer 13) in the stripe-shaped lower electrode 11-1 masked, the lower electrode 11-1 is subjected to anodic oxidation to form a protective insulating layer 11-2. This protective insulating layer 11-2 prevents an electric field from being concentrated on the edge of the lower electrode 11-1. Subsequently, the mask is removed and thereafter, the lower electrode 11-1 is applied with anodic oxidation to form the insulating layer 13 having a very small thickness. The protective insulating layer 11-2 has already been formed into an oxidized film which is left as it is.

Next, an inter-insulating film 14 is formed by keeping the electron-emission area S clear off. The inter-insulating film 14 includes a lower interlayer insulating film 14-1 and an upper interlayer insulating film 14-2 and each of the lower and upper films can be of a silicon oxide or a silicon nitride film. In the event that the protective insulating layer 11-2 formed through anodic oxidation has pinholes, the interlayer insulating films can compensate for the defects to assure insulation between the data line 11 and the scanning line 20 and besides play the role of a flattening layer to be described later.

The lower interlayer insulating film 14-1 is so formed as to have a thickness equal to or larger than a thickness d of the data line 11 and then the upper interlayer insulating film 14-2 having its planar upper surface of unevenness or irregularity depths less than those of its lower surface is formed on the lower interlayer insulating film. An upper electrode 17 constituting a scanning line is formed on the planar interlayer insulating film 14 having its top surface of less uneven depths than those of its bottom surface.

The scanning line 20 as shown in FIGS. 3 and 4 includes a stripe-shaped lower metal film 15, a stripe-shaped upper metal film 16 and the upper electrode 17 also of stripe shape, these films and electrode being laid to intersect the data line 11. For example, aluminum-neodymium alloy (Al—Nd alloy) can be used for the lower metal film 15 and various metallic materials such as for example copper (Cu) or chromium (Cr) can be used for the upper metal film 16.

Used as the upper electrode 17 is, for example, a laminated film of iridium (Ir), platinum (Pt) and gold (Au) which is formed in the upper portion of the scanning line 20. The upper electrode 17 is cut, at its one side facing an adjoining stripe-shaped scanning line 20 (indicated by mark R), along the vertical side wall of the upper metal film 16 beneath the electrode and a recess of the lower metal film 15 whereas it is not cut at its other side (indicated by mark L) where the lower metal film 15 serves as a contact portion so as to cover the interlayer insulating film 14 and insulating layer 13 so that self-aligned intermittent films may be formed consecutively.

When a data signal is applied to a data line 11 in register with a selected scanning line 20 and a voltage is applied across the lower electrode 11-1 of the data line 11 and the upper electrode 17 of the scanning line 20, electrons are emitted from the very thin insulating layer 13 through the influence of the tunnel effect. The thus generated electrons are accelerated by an electric field of several kilovolts applied across cathode substrate 10 and anode substrate 100 to impinge on a fluorescent material 111 (112, 113) on the anode substrate.

The spacers 30 support the cathode substrate 10 and anode substrate 100 to make them withstand atmospheric pressure and for example, plate-like glass, ceramics or synthetic resin is user for the spacer.

Turning now to FIG. 3, the interlayer insulating film 14 will be described in greater detail. The interlayer insulating film 14 is an intermediate layer provided between the cathode substrate 10 and a spacer 30 and is adapted to flatten a portion where a data line 11 is in register with a scanning line 20.

The interlayer insulating film 14 is constructed of two layers of lower interlayer insulating film 14-1 and upper interlayer insulating film 14-2. The lower interlayer insulating film 14-1 is so formed as to have a thickness s which is equal to or larger than the thickness d of data line 11. This enables the lower interlayer insulating film 14-1 to fill a ditches between adjacent data lines 11, so that a layer extending to overlie the data lines 11 can be flattened remarkably. In addition, by forming the upper interlayer insulating film 14-2 on the lower interlayer insulating film 14-1, the layer overlying the data lines can be more flattened.

Since the top surface of upper interlayer insulating film 14-2 (opposing the scanning line 20) is less deepened unevenly than its bottom surface (opposing the data line 11), the scanning line 20 formed on the top surface can be so formed as to also have an almost flattened top surface. Accordingly, pressure by the spacer 20 can be applied to the whole of almost flattened scanning line 20 and in contrast to the prior art, pressure is not applied more intensively to only a portion of scanning line 20 above the data line 11, thus preventing the interlayer insulating film 14 from being broken. In case the interlayer insulating film 14 is so formed as to have a total thickness which is equal to or larger than the thickness d of data line 11, the interlayer insulating film 14 can be of a monolayer structure.

### Embodiment 2

In a second embodiment, data lines 11, interlayer insulating films 14 and scanning lines 20 are formed on a cathode substrate 10 as shown in FIG. 6. The interlayer insulating film 14 less plays the role of a flattening layer. Instead, a thick-film electrode layer 22 serving as an intermediate layer for flattening an overlap portion of the data line 11 and scanning line 20 is formed between a spacer 30 and the scanning line 20. The thick-film electrode layer 22 also functions to reduce the electrical resistance of the scanning line 20. The top surface of thick-film electrode layer 22 (opposing the spacer 30) is less deepened unevenly than its bottom surface (opposing the scanning electrode 20) and is flattened considerably. When a plurality of layers are laminated, it is natural property that the higher a laminated layer, the more its uneven depth decreases. The thick-film electrode layer 22 is formed through screen printing process or dispenser process or by printing a paste including a metallic material such as silver (Ag) and a glass material through ink jet process. This thick-film electrode 22 can be of a single layer or of a double layer as shown at dotted line in FIG. 6.

### Embodiment 3

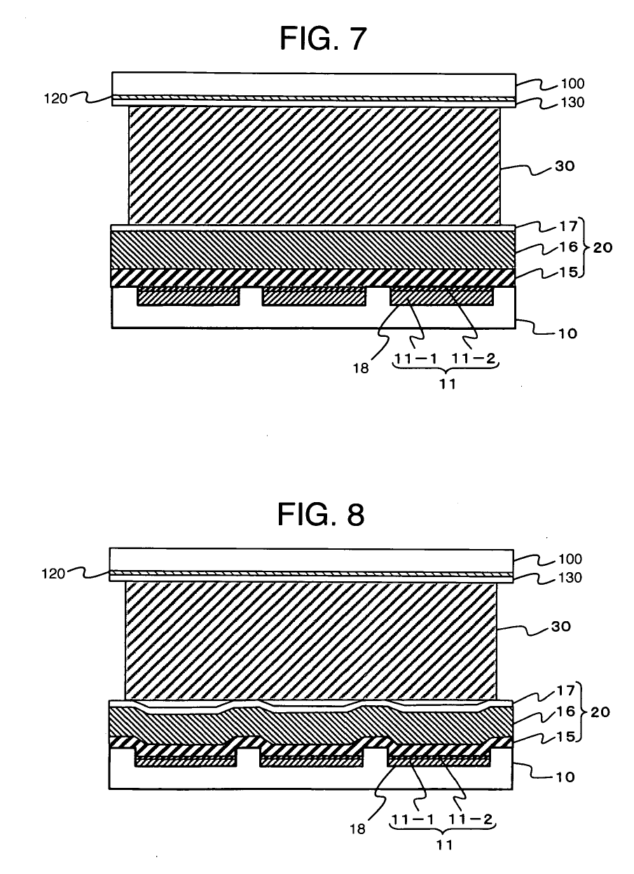

In a third embodiment, recesses 18 are formed in a cathode substrate 10 and data lines 11 are so formed as to be fitted in the recesses as shown in FIG. 7, so that the surface of data line 11 is flush with the surface of the cathode substrate 10. Then, planar scanning lines 20 are formed on the planar cathode substrate 10. With this construction, since pressure from a spacer 30 can be received uniformly by the scanning line 20, insulation between the scanning line 20 and the data line 11 will not be broken down. Accordingly, interlayer short-circuit can be prevented. The insulation between the data line 11 and the scanning line 20 can be kept by the protective insulating layer 11-2. In order to further improve the insulating performance, an interlayer insulating film 14 may be formed between the data line 11 and scanning line 20 within the recess 18.

### Embodiment 4

In the present embodiment, a cathode substrate 10 is formed with recesses 18 and a data line 11 and part of a scanning line 20 are fitted in each of the recesses as shown in FIG. 8. In this case, the scanning line 20 is raised at the boundary between adjacent data lines 11 to receive pressure from a spacer 30 but because of the raised portion of scanning line 20 being at the boundary between adjacent data lines 11, dielectric breakdown will not occur between the scanning line 20 and the data line 11. The insulation between the data line 11 and the scanning line 20 can be kept by the protective insulating layer 11-2. In order to further improve the insulating performance, an interlayer insulating film 14 may be formed between the data line 11 and scanning line 20 within the recess 18.

It should be further understood by those skilled in the art that although the foregoing description has been made on embodiments of the invention, the invention is not limited thereto and various changes and modifications may be made without departing from the spirit of the invention and the scope of the appended claims.

1. An image display apparatus comprising:
a cathode substrate formed with electron-emission areas, data lines and scanning lines intersecting the data lines;
an anode substrate arranged to oppose said cathode substrate and having fluorescent materials which are caused to luminesce under impingement thereon of electrons emitted from said electron-emission areas;
spacers provided above said scanning lines between said cathode substrate and said anode substrate to maintain a gap between said cathode substrate and said anode substrate; and
an intermediate layer provided between said cathode substrate and said anode substrate, the surface of said intermediate layer opposing said spacer being less deepened unevenly than its surface opposing said cathode substrate.

2. An image display apparatus according to claim 1, wherein said intermediate layer is an interlayer insulating film provided between said data line and said scanning line and the surface of said interlayer insulating film opposing said scanning line is less deepened unevenly than its surface opposing said data line.

3. An image display apparatus according to claim 2, wherein said interlayer insulating film is formed on said data line and has its thickness which is equal to or larger that a thickness of said data line.

4. An image display apparatus according to claim 3, wherein said interlayer insulating film is formed of two different layers.

5. An image display apparatus according to claim 1, wherein said intermediate layer is a thick-film electrode layer provided between said scanning line and said spacer and the surface of said thick-film electrode layer opposing said spacer is less deepened unevenly than its surface opposing said scanning line.

6. An image display apparatus according to claim 5, wherein said thick-film electrode layer is formed of two different layers.

7. An image display apparatus comprising:
a cathode substrate formed with electron-emission areas, data lines and scanning lines intersecting the data lines;
an anode substrate arranged to oppose said cathode substrate and having fluorescent materials which are caused to luminesce under impingement thereon of electrons emitted from said electron-emission areas;
spacers provided above said scanning lines between said cathode substrate and said anode substrate to maintain a gap between said cathode substrate and said anode substrate; and
recesses formed in said cathode substrate and in which said data lines are fitted, said scanning lines being formed above the data lines fitted in said recesses through an insulating film.

8. An image display apparatus according to claim 7, wherein said insulating film on said data line fitted in said recess has a flat surface contacting said scanning line.

9. An image display apparatus according to claim 7, wherein part of said scanning line is also fitted in said recess formed in said cathode substrate.

10. An image display apparatus according to claim 9, wherein said insulating film on said data line fitted in said recess has a flat surface contacting said scanning line.
